(19) United States
(12) Patent Application Publication
(10) Pub. No.: US 2016/0303802 A1
(43) Pub. Date: Oct. 20, 2016

(54) EXTRUDER SYSTEM FOR ADDITIVE MANUFACTURING

(71) Applicant: FLEXI MATTER LTD., Meishar (IL)

(72) Inventors: Meyshar MESHORER, Meishar (IL); Alexander Vasilevski, Jerusalem (IL)

(21) Appl. No.: 15/097,314

(22) Filed: Apr. 13, 2016

Related U.S. Application Data
(60) Provisional application No. 62/147,051, filed on Apr. 14, 2015.

(51) Int. Cl. B29C 67/00; B33Y 30/00; B29B 15/00; B29B 7/42; B29B 13/02

(52) U.S. Cl. CPC B29C 67/0085; B29C 67/0055; B29B 7/428; B29B 13/02; B29B 15/00; B33Y 30/00

(57) ABSTRACT

An extruder system for additive manufacturing is disclosed. The extruder system comprises: a heatable elongated barrel having a nozzle at a tip thereof; and an extrusion screw mounted coaxially and rotatably in the barrel, such that upon rotation of the screw in the barrel an additive manufacturing building material is advanced in the barrel towards the tip; the screw having therein an axial bore configured for receiving at least one elongated mechanical member for controllably varying at least one of an amount and a type of material extruded through the nozzle.

### CROSS-REFERENCE TO RELATED APPLICATIONS

This application claims the benefit of U.S. Provisional Patent Application No. 62/147,051, filed Apr. 14, 2015, which is hereby incorporated by reference.

### FIELD AND BACKGROUND OF THE INVENTION

The present invention, in some embodiments thereof, relates to extrusion additive manufacturing and, more particularly, but not exclusively, to an extruder system for additive manufacturing and uses thereof.

An extrusion-based additive manufacturing system builds a three-dimensional object from a digital representation of the 3D object in a layer-by-layer manner by extruding a flowable modeling material. The modeling material is extruded through an extrusion tip carried by an extrusion head on a support platform in an x-y plane. The extruded modeling material fuses to previously deposited layer of modeling material, and solidifies when cooled off.

Movement of the extrusion head with respect to the support platform is performed under computer control, in accordance with build data that represents the 3D object. The build data is obtained by initially slicing the digital representation of the 3D object into multiple horizontally sliced layers. Then, for each sliced layer, the host computer generates a build path for depositing modeling material to form the 3D object.

The extrusion head extrusion-based additive manufacturing systems includes a smooth cylindrical barrel fitted with an extruder screw having helical channels such that rotation of the screw advances the modeling material toward a discharge nozzle at the tip of the extrusion head. The modeling material extrusion head is heated by means of a heater that is in thermal contact with the barrel.

### SUMMARY OF THE INVENTION

According to an aspect of some embodiments of the present invention there is provided an extruder system for additive manufacturing, the extruder system comprising: a heatable elongated barrel having a nozzle at a tip thereof; and an extrusion screw mounted coaxially and rotatably in the barrel, such that upon rotation of the screw in the barrel an additive manufacturing building material is advanced in the barrel towards the tip; the screw having therein an axial bore configured for receiving at least one elongated mechanical member for controllably varying at least one of an amount and a type of material extruded through the nozzle.

According to some embodiments of the invention the at least one elongated mechanical member comprises a tubular element, arranged coaxially within the bore and being axially movable therein to controllably engage and disengage the nozzle.

According to some embodiments of the invention the tubular element comprises at least one opening formed in a wall thereof, to allow building material advanced by the screw to enter the tubular element through the at least one opening, so that when the tubular element engages the nozzle, the nozzle is fed by building material from the tubular element.

According to some embodiments of the invention the at least one mechanical member comprises a rod fitted within the tubular element and being axially movable therein and over at least one opening to control an amount of building material flowing through the at least one opening.

According to some embodiments of the invention when the tubular element is disengaged from the nozzle, the nozzle is fed by building material bypassing the tubular element.

According to some embodiments of the invention the at least one elongated mechanical member comprises a rod fitted within the bore and being axially movable therein to controllably engage and disengage the nozzle.

According to some embodiments of the invention the tubular element is configured to guide additive material to move within the tubular element into the nozzle, and to allow building material advanced by the screw to bypass the tubular element and also to exit through the nozzle, thereby to combine the additive material and the building material.

According to some embodiments of the invention the at least one elongated mechanical member comprises a tubular element arranged coaxially within the bore to engage the nozzle, the tubular element being configured to guide additive material to move within the tubular element into the nozzle, and to allow building material advanced by the screw to bypass the tubular element and also to exit through the nozzle, thereby to combine the additive material and the building material.

According to some embodiments of the invention the tubular element is configured to form an extruded contour having a core-shell structure, wherein the additive material constitutes the core, and wherein the building material constitutes the shell.

According to some embodiments of the invention the system comprises a locomotion device for conveying the additive material through the tubular element.

According to some embodiments of the invention the additive material is a gaseous substance.

According to some embodiments of the invention the additive material is a foamed substance.

According to some embodiments of the invention the locomotion device comprises a pump.

According to some embodiments of the invention the additive material is a solid thread.

According to some embodiments of the invention the additive material is a fibrous substance.

According to some embodiments of the invention the locomotion device comprises a pushing member introducible into the tubular element to push the additive material through the tubular element.

According to some embodiments of the invention the additive material is a pigment.

According to some embodiments of the invention the tubular element has a thermally isolating wall.

According to some embodiments of the invention the tubular element comprises a plurality of lumens for guiding a plurality of different types of additive materials therein.

According to some embodiments of the invention the tubular element comprises at least one valve for controlling at least one of an amount and a type of additive material guided into the nozzle.

According to some embodiments of the invention the system comprises a rotation device configured for rotating the nozzle about an axis of the barrel.

According to some embodiments of the invention the system comprises a rotation device configured for rotating the tubular element about an axis of the tubular element, relative to the barrel.

According to an aspect of some embodiments of the present invention there is provided an additive manufacturing system. The additive manufacturing system comprises the extruder system as delineated above and optionally and preferably as further detailed below.

According to an aspect of some embodiments of the present invention there is provided a method of additive manufacturing of a three-dimensional object. The method comprises: introducing a building material into an extruder system; and operating the extruder system to extrude contours of a modeling material to form a plurality of layers corresponding to slice data of the object; wherein the extruder system comprises a heatable elongated barrel having a nozzle at a tip thereof, and an extrusion screw mounted coaxially and rotatably in the barrel, such that upon rotation of the screw in the barrel an additive manufacturing building material is advanced in the barrel towards the tip, the screw having therein an axial bore configured for receiving at least one elongated mechanical member for controllably varying at least one of an amount and a type of material extruded through the nozzle.

According to some embodiments of the invention the at least one elongated mechanical member comprises a tubular element, arranged coaxially within the bore and being axially movable therein, and the method comprises controlling the tubular element to engage and disengage the nozzle.

According to some embodiments of the invention the tubular element comprises at least one opening formed in a wall thereof, to allow building material advanced by the screw to enter the tubular element through the at least one opening, so that when the tubular element engages the nozzle, the nozzle is fed by building material from the tubular element.

According to some embodiments of the invention the at least one mechanical member comprises a rod fitted within the tubular element and being axially movable therein and over at least one opening, and the method comprises controlling an amount of building material flowing through the at least one opening by moving the rod over the at least one opening.

According to some embodiments of the invention the method comprises disengaging the tubular element from the nozzle, to allow the nozzle to be fed by building material bypassing the tubular element.

According to some embodiments of the invention the at least one elongated mechanical member comprises a rod fitted within the bore and being axially movable. therein, and the method comprises controlling the rod to engage and disengage the nozzle.

According to some embodiments of the invention the method comprises introducing additive material into the tubular element to move within the tubular element into the nozzle, while allowing building material advanced by the screw to bypass the tubular element and also to exit through the nozzle, thereby combining the additive material and the building material.

According to some embodiments of the invention the at least one elongated mechanical member comprises a tubular element arranged coaxially within the bore to engage the nozzle, and the method comprises introducing additive material into the tubular element to move within the tubular element into the nozzle, while allowing building material advanced by the screw to bypass the tubular element and also to exit through the nozzle, thereby combining the additive material and the building material.

According to some embodiments of the invention, combing comprises forming an extruded contour having a core-shell structure, wherein the additive material constitutes the core, and wherein the building material constitutes the shell.

According to some embodiments of the invention the additive material is a gaseous substance According to some embodiments of the invention the additive material is a foamed substance. According to some embodiments of the invention the additive material is a solid thread. According to some embodiments of the invention the additive material is a fibrous substance. According to some embodiments of the invention the additive material is a pigment.

According to some embodiments of the invention the tubular element comprises a plurality of lumens, and the method comprises introducing different types of additive materials to at least two separate lumens.

According to some embodiments of the invention the method comprises rotating the nozzle about an axis of the barrel.

According to some embodiments of the invention the method comprises rotating the tubular element about an axis of the tubular element, relative to the barrel.

According to an aspect of some embodiments of the present invention there is provided an additive manufacturing system, comprising an extruder system and at least one controller, wherein the at least one controller comprises dedicated circuitry configured for executing the method as delineated above and optionally and preferably as further detailed below.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of additive manufacturing system an extruder system according to some embodiments of the present invention;

FIG. 2A is a planar view of an extruder system, according to some embodiments of the present invention;

FIG. 2B is a cross-sectional view along the line A-A taken in FIG. 2A, in embodiments of the invention in which the extruder system comprises a movable tubular element, showing the movable tubular element engaging the nozzle of the extruder system;

FIG. 2C is a fragmentary enlarged cross-sectional view of the section B taken in FIG. 2B, according to some embodiments of the present invention;

FIG. 3A is across-sectional view along the line A-A taken in FIG. 2A, in embodiments of the invention in which the extruder system comprises a movable tubular element, showing the movable tubular element disengaged from the nozzle of the extruder system;

FIG. 3B is a fragmentary enlarged cross-sectional view of the section B taken in FIG. 3A, according to some embodiments of the present invention;

FIG. 4A is a cross-sectional view along the line A-A taken in FIG. 2A, in embodiments of the invention in which the extruder system comprises rod fitted within a bore of a screw, showing the rod engaging the nozzle of the extruder system;

FIG. 4B is a fragmentary enlarged cross-sectional view of the section D en in FIG. 4A, according to some embodiments of the present invention;

FIG. 5A is a cross-sectional view along the line A-A taken in FIG. 2A, in embodiments of the invention in which the extruder system comprises rod fitted within a bore of a screw, showing the rod is disengaged from the nozzle of the extruder system;

FIG. 5B is a fragmentary enlarged cross-sectional view of the section B taken in FIG. 5A, according to some embodiments of the present invention;

FIG. 6A is a cross-sectional view along the line A-A taken in FIG. 2A, in embodiments of the invention in which the extruder system includes a tubular element that guides a fluid or foamed additive material;

FIG. 6B is a fragmentary enlarged cross-sectional view of the section B taken in FIG. 6A, according to some embodiments of the present invention;

FIG. 7A is a cross-sectional view along the line A-A taken in FIG. 2A, in embodiments of the invention in which in which the extruder system includes a tubular element that guides a solid additive material;

FIG. 7B is a fragmentary enlarged cross-sectional view of the section taken in FIG. 7A, according to some embodiments of the present invention;

FIG. 8A is a cross-sectional view along the line A-A taken in FIG. 2A, in embodiments of the invention in which the extruder system includes a tubular element having a plurality of lumens for guiding a plurality of different types of additive materials therein;

FIG. 8B is a fragmentary enlarged cross-sectional view of the section B taken in FIG. 8A, according to some embodiments of the present invention;

FIG. 8C is a fragmentary enlarged cross-sectional view of the section D taken in FIG. 8B, according to some embodiments of the present invention;

FIG. 8D is a cross-sectional view along the line E-E taken in FIG. 8A, according to some embodiments of the present invention;

FIG. 8E is a fragmentary enlarged cross-sectional view of the section F taken in FIG. 8D, according to some embodiments of the present invention;

FIG. 9A is a cross-sectional view along the line A-A taken in FIG. 2A, in embodiments of the invention in which the extruder system comprises a rotation device;

FIG. 9B is a fragmentary enlarged cross-sectional view of the section B taken in FIG. 9A, according to some embodiments of the present invention;

FIG. 10 is a schematic illustration of an extruded contour having a core-s ell structure; and

FIG. 11 is a flowchart diagram of a method suitable for additive manufacturing of a three-dimensional object, according to some embodiments of the present invention.

### DESCRIPTION OF SPECIFIC EMBODIMENTS OF THE INVENTION

The present invention, in some embodiments thereof, relates to extrusion additive manufacturing and, more particularly, but not exclusively, to an extruder system for additive manufacturing and uses thereof.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

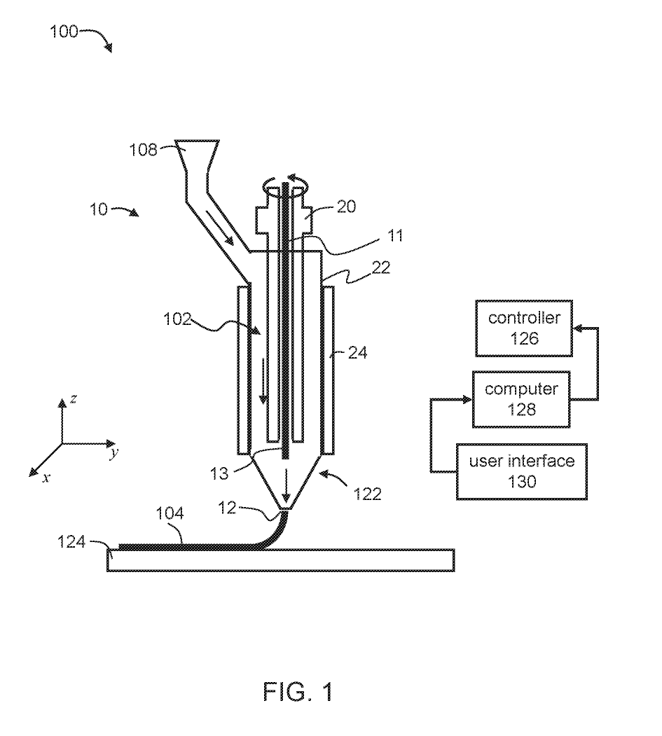

FIG. 1 is a schematic illustration describing an overview of extrusion additive manufacturing system 100, according to some embodiments of the present invention. System 100 comprises an extruder system 10 for extruding contours 104 of building material onto a supporting platform 124 or onto previously extruded building material contours supported by supporting platform 124.

Extruder system 10 can comprise a heatable elongated extrusion barrel 22 for holding the building material 102, a motor-driven rotating screw 20 mounted coaxially and rotatably in barrel 22 for forcing the building material through extrusion barrel 22, and a hollow tip 122 having a nozzle 12 through which the building material is extruded onto supporting platform 124 or onto a previously formed extruded layer. Upon rotation of screw 20 in barrel 22 an additive manufacturing building material is advanced in barrel 22 towards tip 122.

System 10 can further comprise a feed hopper 108 for providing building material to extruder 10, and a heater 24 for heating the building material in extrusion barrel 22. The power to heater 24 is supplied by power line 25.

Extruder system 10 is optionally and preferably designed in accordance with the building material being extruded.

As used herein “building material” encompasses both a material extruded to form the structure of the 3D object, and a support material which is extruded to support the 3D object, and which is thereafter removed as known in the art.

As used herein, “modeling material” refers to any material that constitutes the final object to be fabricated once all the building and post building operations are completed.

Representative examples of modeling materials that can be extruded by extruder system 10, include, without limitation, a polymeric material, a wax material, a ceramic material, a metal, a metal alloy, composite material, material enforced by a fiber, such as, but not limited to, glass, carbon, wood, metal, and the like. The modeling material can be supplemented with an aqueous or non-aqueous binder and/or an additive such as, but not limited to, a viscosity modifier, a dispersant, and a lubricant. In some embodiments of the present invention extruder 10 extrudes only modeling material, and does not extrude any support material, throughout the fabrication of the object. In some embodiments, system 10 is devoid of any extruder that extrudes support material.

As used herein, “support material” refers to material that is dispensed to support the object being built and that is ultimately separated from the object in a post-build operation.

In various exemplary embodiments of the invention tip 122 of extruder system 10 has a diameter of from about 0.3 mm to about 50 mm, or about 0.3 mm to about 5 mm, or from about 20 mm to about 50 mm.

For extruding the modeling material, the material is fed into extrusion barrel 22 where it is melted by heater 24 and pressurized to flow through tip 122 by means of rotating screw 20.

System 100 also comprises a controller 126 operatively associated with a computer 128. In some embodiments of the present invention system 100 further comprises computer 128. Controller 126 receives slide data of an object to be fabricated from computer 128 and controls extruder system 10 to extrude contours of the modeling material thereby to form on supporting platform 124 a plurality of layers corresponding to the slice data. Controller 126 can communicate with any of the components of extruder system 10 and platform 124 via communication lines (not shown) or wirelessly.

System 100 can also comprise a user interface 130 for allowing the operator to provide various parameters as an input to system 100.

Any of extruder system 10 and supporting platform 124 can be movable horizontally and/or vertically, so as to establish relative motion between extruder system 10 and platform 124, wherein the horizontal motion facilitates the patterning of the individual layers, and the vertical motion facilitates the buildup of the layers on top of each other as known in the art. Thus, for example, in some embodiments extruder system 10 is static and supporting platform 124 is movable both horizontally and vertically, in some embodiments extruder system 10 is movable both horizontally and vertically and supporting platform 124 is static, in some embodiments both extruder system 10 and supporting platform 124 are movable both horizontally and vertically (for example, in opposite directions), in some embodiments extruder system 10 is movable horizontally and supporting platform 124 is movable vertically, in some embodiments extruder system 10 is movable both horizontally and vertically, and supporting platform 124 is movable only vertically, in some embodiments extruder system 10 is movable vertically and supporting platform 124 is movable horizontally, and in some embodiments extruder system 10 is movable only vertically and supporting platform 124 is movable both horizontally and vertically. The relative motion between extruder system 10 and platform 124 is controlled by controller 126 based on slice data received by controller 126 from computer 128.

The operation of system 100 is based on slice data that is typically received as a data file containing three-dimensional contour coordinates which define a plurality of planes corresponding to planar slices of the object, such that the overall shape of the object is described by the slices. Typically, the data file is in a format that is readable by the controller of the system. Representative examples of computer readable formats suitable for the present embodiments include, without limitation, STL, DWG/DXF, IDEAS, TOES, and VRML. The data file can be processed, preferably by computer 128, wherein the processing may include various operations, including, without limitation, updating of vertical coordinates, updating of horizontal coordinates, ordering and reordering of contours, updating extrusion paths, and the like. Representative examples of processing techniques are described hereinunder. Once the data file is processed, the slice data are transferred from computer 128 to controller 126, which controls the operation of extruder system 10, and optionally also platform 124. Controller 126 signals extruder system 10 to extrude the modeling material onto platform 212 and also signals at least one of extruder system 10 and platform 124 to move along the vertical and horizontal direction, according to the slice data.

FIG. 1 also shows a three-dimensional Cartesian coordinate system, defining an x direction a y direction and a z direction. Herein, “vertical direction” refers to a direction which is parallel or anti-parallel to the z direction, and a “horizontal direction” refers to any direction parallel to or in the x-y plane.

In various exemplary embodiments of the invention screw 20 has therein an axial bore 11 configured for receiving one or more elongated mechanical members 13 for controllably varying the amount and/or type of the material extruded through nozzle 12.

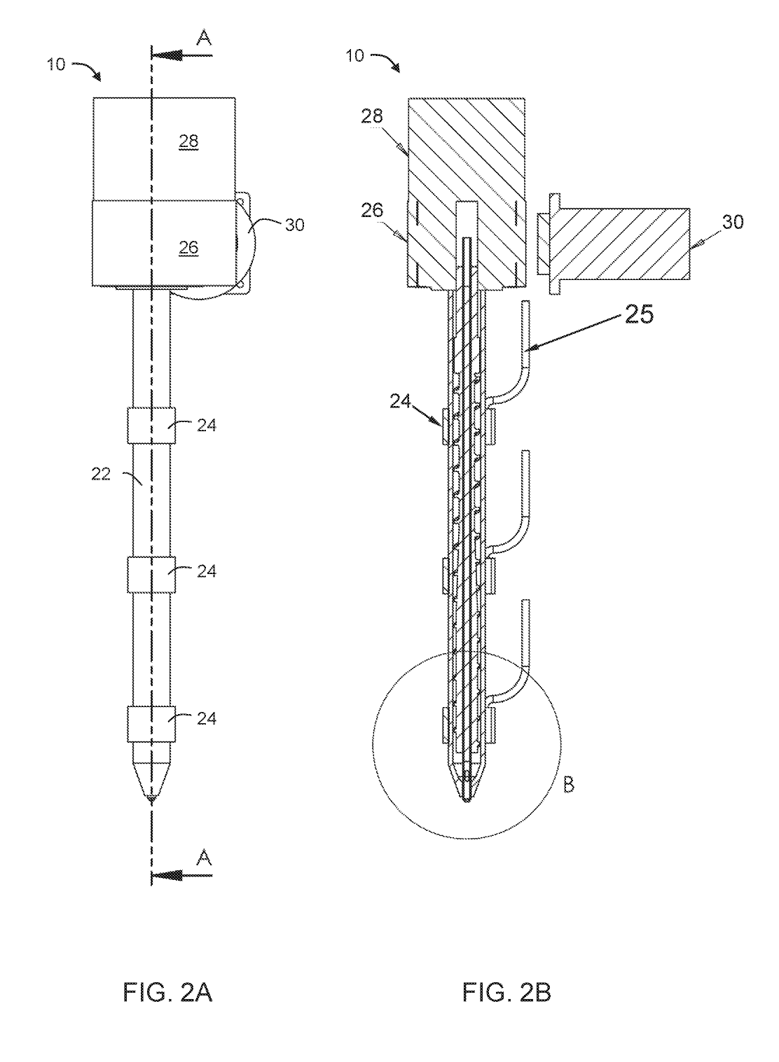

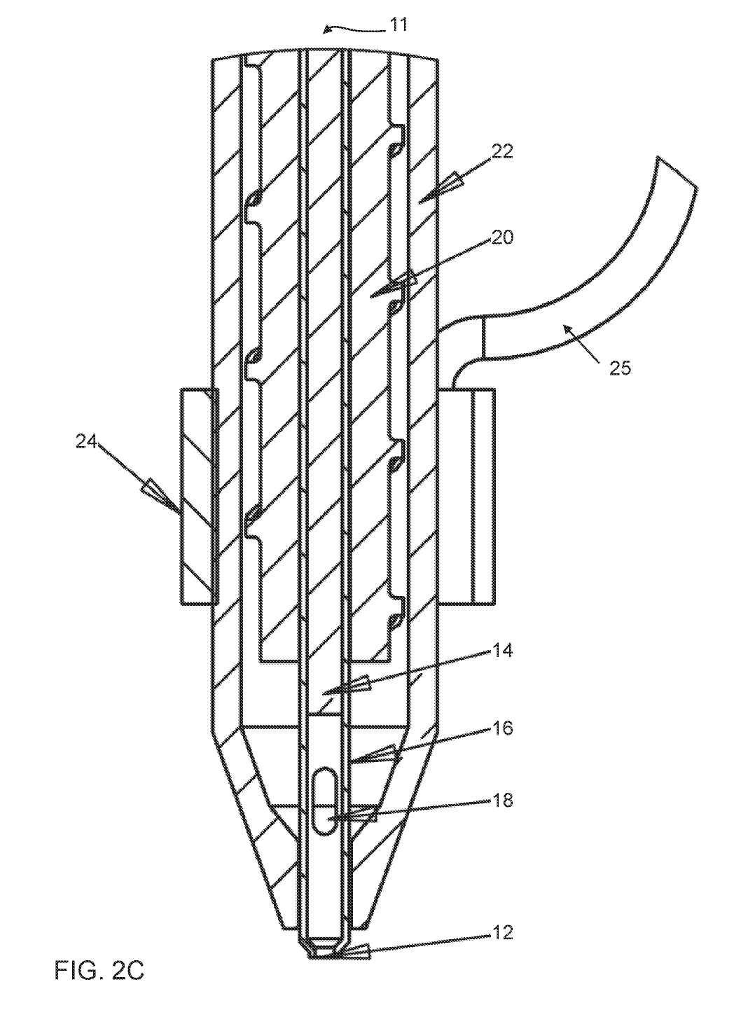

Referring conjointly to FIGS. 2A-9B, extruder system 10 optionally and preferably comprises a motor 30 for rotating the screw 20, preferably by means of a transmission gear 26, and an extruder controller 28 that controls the operations of screw 20 and other components of the extruder system (e.g., the elongated mechanical member) as described herein. Preferably, extruder controller 28 communicates with the controller 126 of the additive manufacturing system 100, wherein controller 126 transmits operation signals to extruder controller 28 based on the slice data and the additive manufacturing procedure. Alternatively, controller 126 can directly control also the components of extruder system 10, in which case in is not necessary for system 10 to include a controller. Still alternatively, controller 28 can directly control also the relative motion between extruder system 10 and platform 124, and directly receive data from computer 128 in which case in is not necessary for system 100 to include controller 126.

A planar view of an extruder system according to various exemplary embodiments of the present invention is illustrated in FIG. 2A. FIGS. 2B-C and 3A-B are schematic illustrations of extruder system 10 in embodiments of the invention in which the elongated mechanical member 13 comprises a tubular element 16 arranged coaxially within bore 11. Tubular element 16 has an outer wall sizewise compatible with the inner wall of bore 11. Optionally and preferably the outer wall of tubular element 16 is generally cylindrical, and in some embodiments the distal end (downstream the extrusion direction) of the outer wall of tubular element 16 is tapered.

In some embodiments of the present invention tubular element 16 has a thermally isolating wall, and in some embodiments of the present invention tubular element 16 has a thermally conductive. When the wall of tubular element 16 is thermally isolating, the thermal conductance of the wall of tubular element 16 is less than the thermal conductance of the wall of extrusion barrel 22, and when the wall of tubular element 16 is thermally conductive, the thermal conductance of the wall of tubular element 16 is generally the same (e.g., within 10%) or above the thermal conductance of the wall of extrusion barrel 22. A thermally isolating tubular element is typically useful in embodiments in which an additive material is introduced into tubular element, as further detailed hereinbelow, and it is desired not to overheat the additive material. A thermally conductive tubular element is typically useful in embodiments in which a liquefiable building material is allowed to enter tubular element 16, e.g., through one or more openings 18 formed in the wall of tubular element 16, as further detailed hereinbelow.

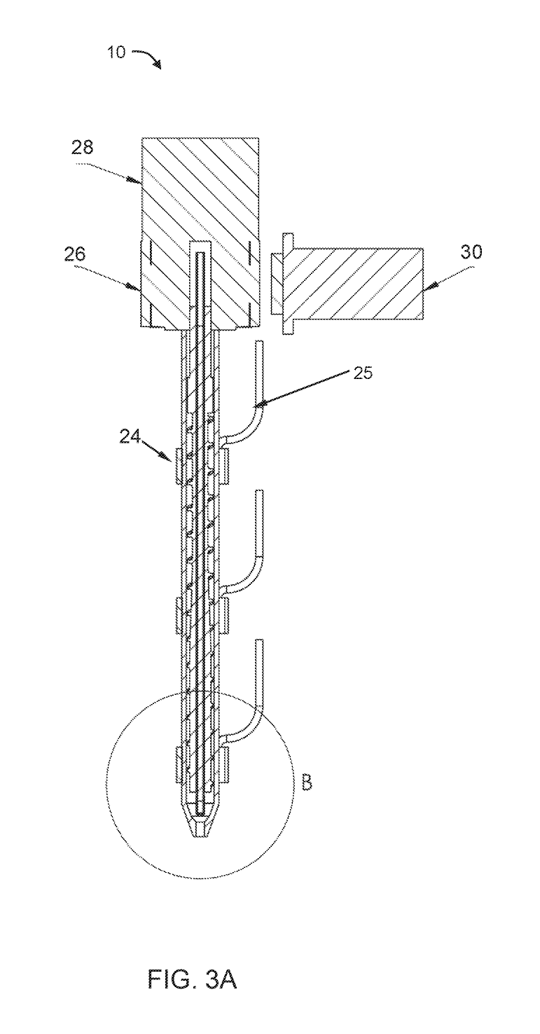

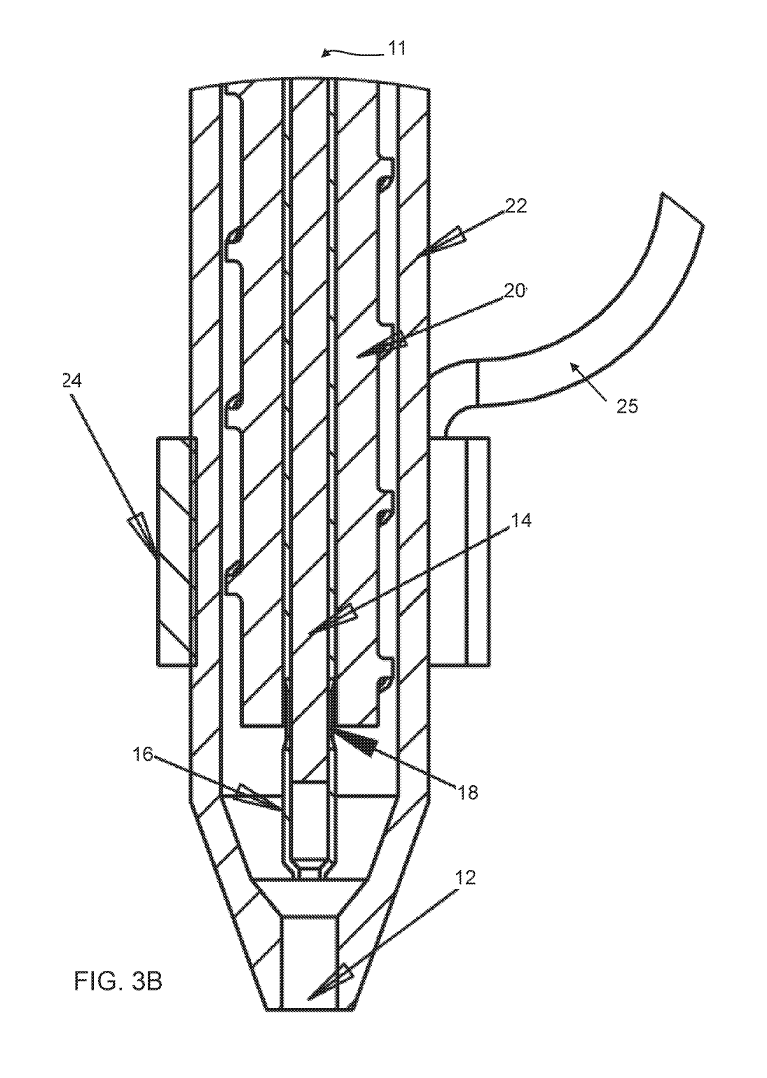

In various exemplary embodiments of the invention tubular element 16 is axially movable in bore 11 to controllably engage (FIGS. 2B-C) and disengage (FIGS. 3A-B) nozzle 12. The motion of tubular element 16 is optionally and preferably controlled by extruder controller 28.

In some embodiments of the present invention tubular element 16 comprises one or more openings 18 formed in a wall of tubular element 16. Opening(s) 18 serve for allowing a building material advanced by screw 20 to enter tubular element 16 through opening 18. When tubular element 16 engages nozzle 12 (FIGS. 2B and 2C) nozzle 12 is fed by building material from tubular element 16, and when tubular element 16 is disengaged from nozzle 12 (FIGS. 3A and 3B) nozzle 12 is fed by building material that advances outside tubular element 16 and bypasses tubular element 16 into nozzle 12.

The advantage of having a movable tubular element within bore 11 is that is allows controlling the amount of building material that is extruded through nozzle 12. This can be done in more than one way. In some embodiments, the size of opening(s) 18 is less than the aperture size of nozzle 12, so that when tubular element 16 engages nozzle 12, less amount of building material exits through nozzle 12. In these embodiments, tubular element 16 is tightly fitted to nozzle 12 so that upon engagement of tubular element 16 into nozzle 12, only building material that is advanced through tubular element 16 enters nozzle 12, while building material that advances outside tubular element 16 is prevented from entering nozzle 12.

In some embodiments, extruder system 10 comprises a rod 14 fitted within tubular element 16. Rod 14 is optionally and preferably axially movable in tubular element 16 and over opening(s) 18. Rod 14 serves as a valve that controls the amount of building material flowing through opening 18. In the illustration shown in FIGS. 2B-C, rod 14 is in an upper position relative to opening(s) 18 so that opening(s) 18 is/are fully open. In the illustration shown in FIGS. 3A-B, rod 14 covers opening(s) 18 so that opening(s) 18 is/are closed and building material does not enter tubular element 16. Positions of rod 14 in which rod 14 partially closes opening(s) 18 are also contemplated.

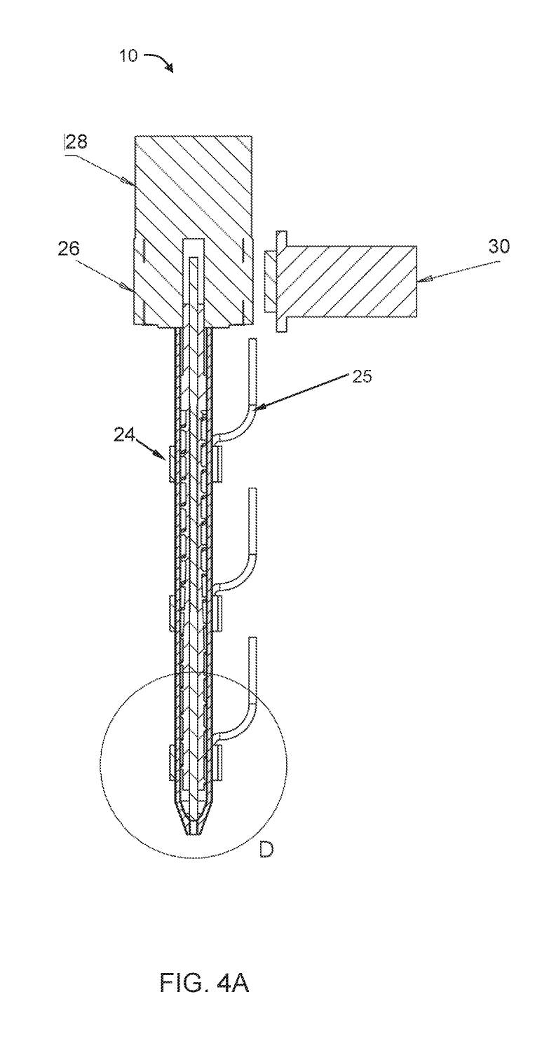

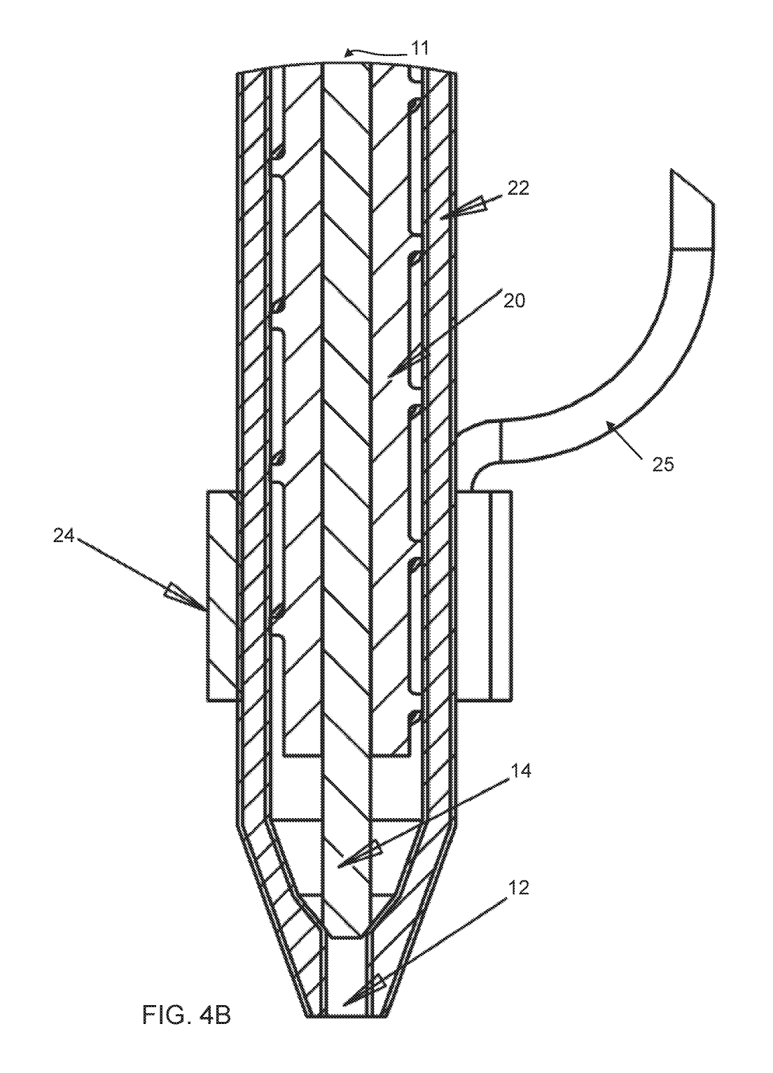

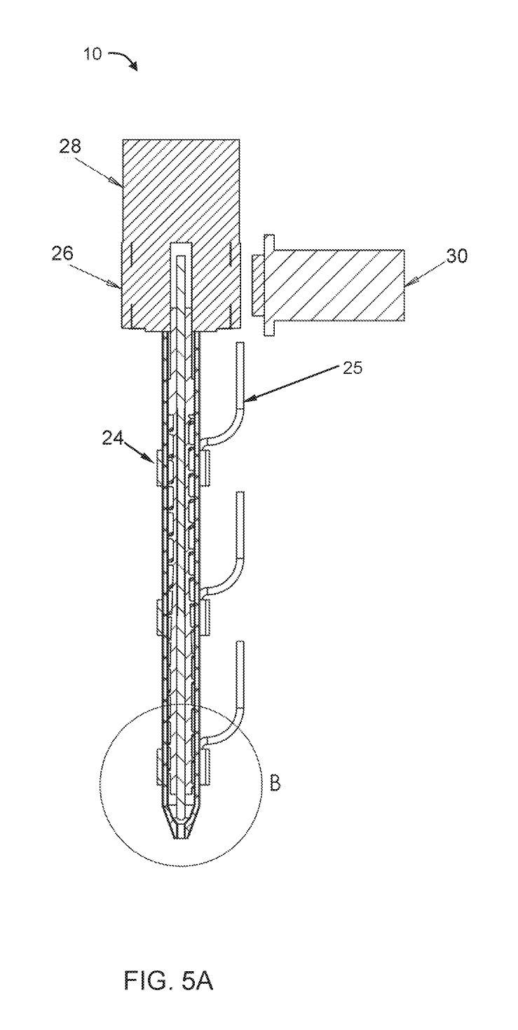

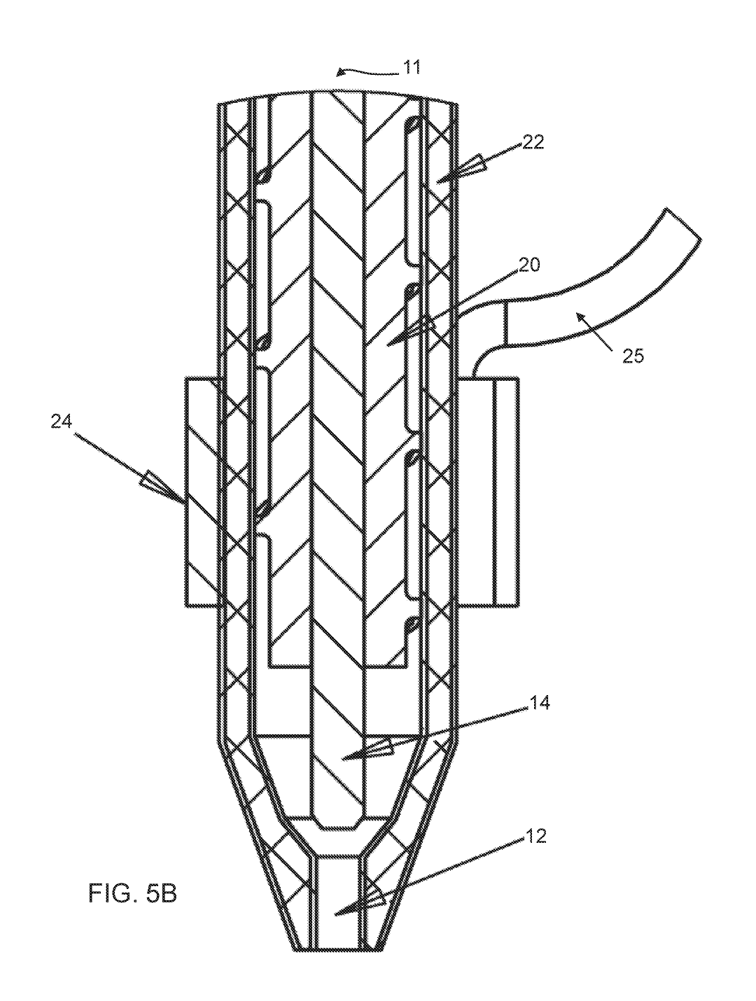

The present embodiments also contemplate configurations in which extruder system 10 does not include a movable tubular element such as element 16. Representative examples of these embodiments are illustrated in FIGS. 4A-B and 5A-B which are cross-sectional views along the line A-A taken in FIG. 2A, in embodiments of the invention in which the elongated mechanical member 13 comprises rod 14. Rod 14 is optionally and preferably fitted within bore 11 and is axially movable within bore 11 to controllably engage (FIGS. 4A-B) and disengage (FIGS. 5A-B) nozzle 12. When rod 14 is disengaged and away from nozzle 12 (for example, above tip 122) building material is allowed to exit through nozzle 12. For a given rotation speed of screw 20, the amount of building material that enters nozzle 12 is reduced as rod 14 advances towards nozzle 12 due to the space occupied by rod 14. Preferably, when rod 14 engages nozzle 12 no building material exits through nozzle 12.

The motion of rod 14 is optionally and preferably controlled by extruder controller 28.

The control over the amount of building material that exits nozzle 12 depends on several parameters such as the rotation speed of screw 20, the position of rod 14 (if exists) and/or the position of tubular element 16 (is exists). in various exemplary embodiments of the invention two or more of these parameters are synchronized, optionally and preferably by extruder controller 28. Typically, the rotation speed of screw 20 is synchronized with at least one of the position of rod 14 and the position of tubular element 16. For example, when the rotation speed of screw 24) is reduces, rod 14 and/or tubular element 16 are repositioned to reduce the amount of building material that is extruded. When the rotation speed of screw 20 is increased, rod 14 and/or tubular element 16 are preferably repositioned to increase the amount of building material that is extruded.

The synchronization is optionally and preferably also with respect to the additive manufacturing protocol. For example, while moving extruder system 10 to a starting point of a contour, controller 126 can signal extruder controller 28 to bring rod 14 and/or tubular element 16 to a position in which no building material exits nozzle 12. Once tip 122 is accurately located above the starting point of the contour, controller 126 can signal extruder controller 28 to begin the extrusion process, in which case extruder controller 28 can establish the rotation of screw 20 (e.g., by controlling motor 30 and/or gear 26), and retract rod 14 and/or tubular element 16 to allow the building material to exit nozzle 12 at an amount that is preselected for the starting point of the contour. While the contour is extruded, extruder controller 28 can vary the amount of extruded material, if desired. Such variation can be executed so as to vary the thickness of the contour and/or responsively to the speed of extruder system 10 relative to tray 124. Upon reaching the end point of a contour, controller 126 can signal system 10 and/or tray 124 no to move one with respect to the other, and also signal extruder controller 28 to reduce the rotation speed of screw 20, and to advance at least one of rod 14 and/or tubular member towards nozzle 12.

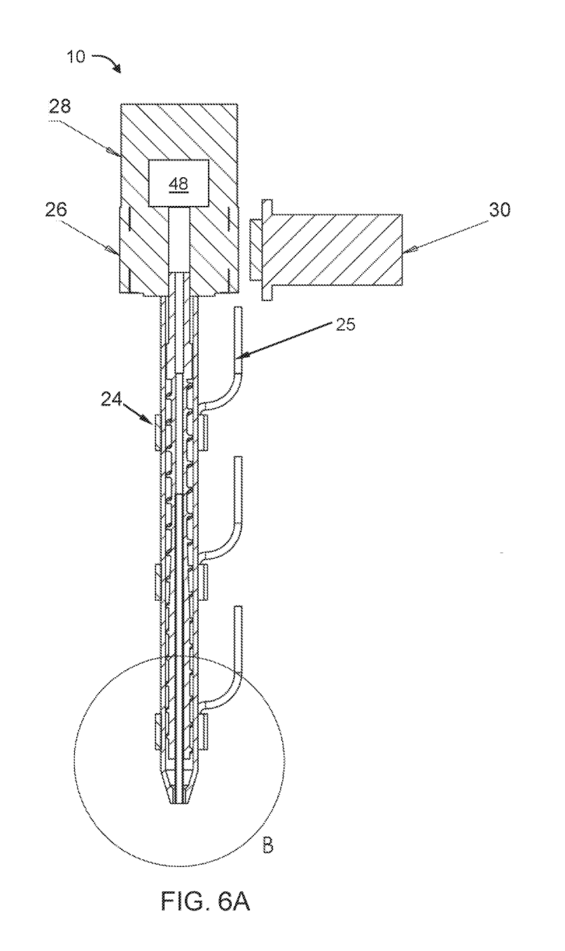

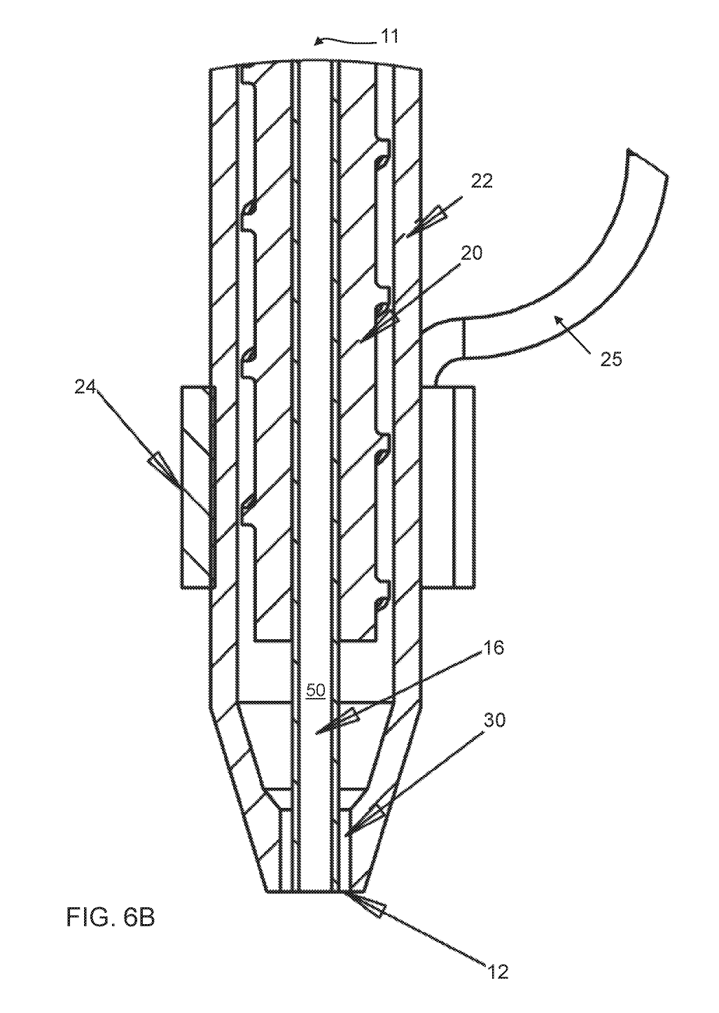

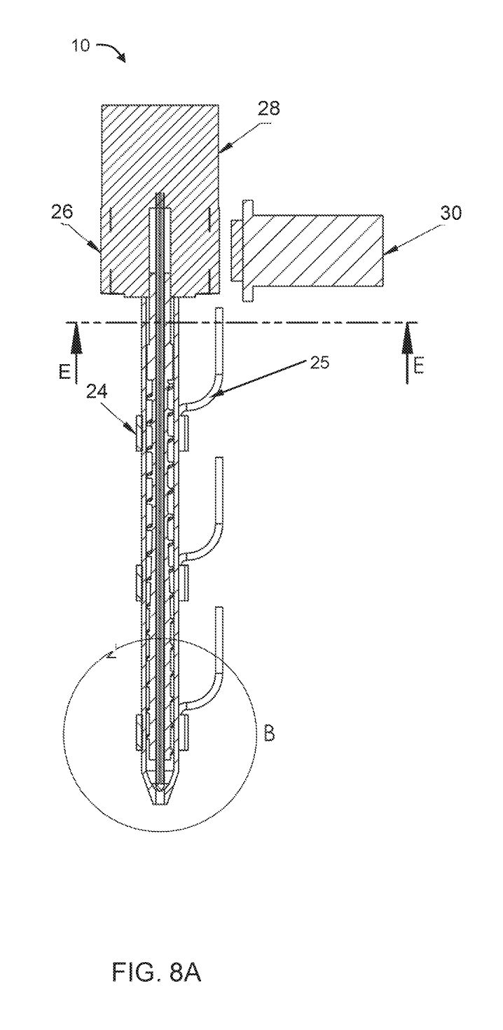

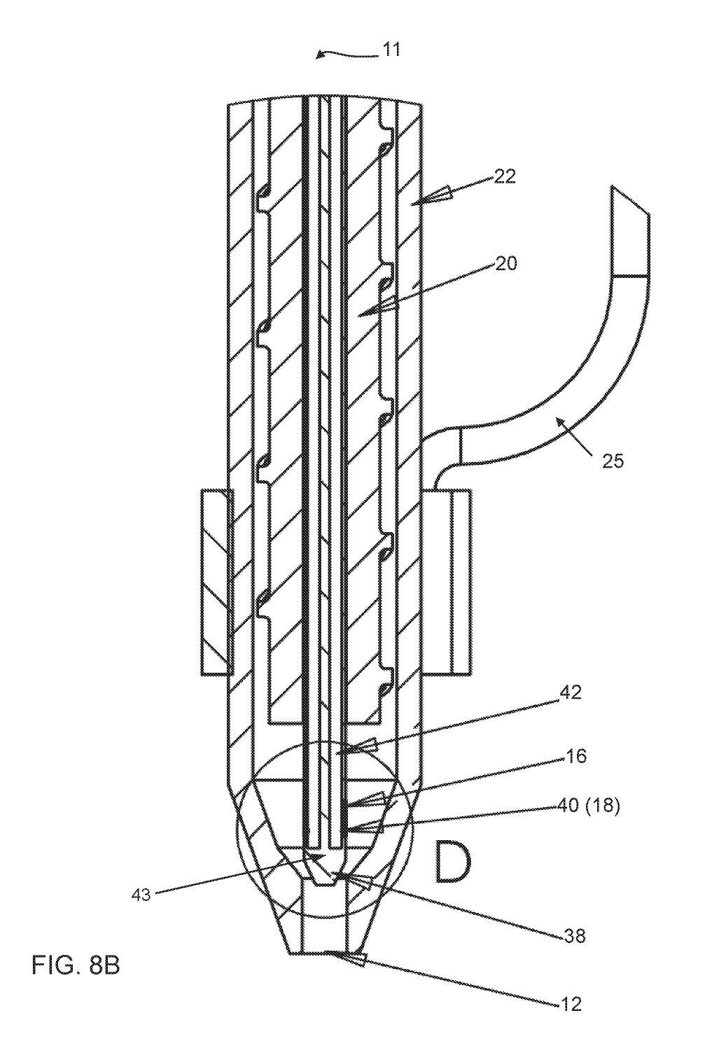

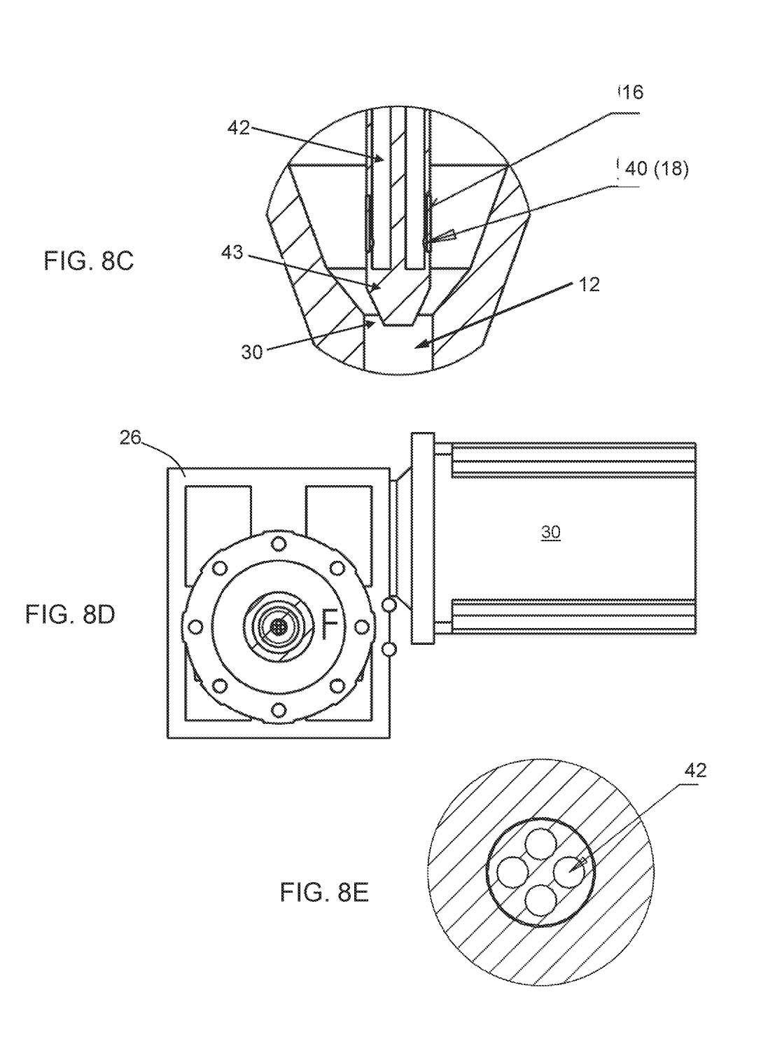

FIGS. 6A-B and 7A-B are schematic illustrations of extruder system 10 is embodiments of the invention in which tubular element 16 guides on additive material to move within tubular element 16 into nozzle 12. These embodiments are particularly useful in situations in which it is desired to produce contours that combine two or more different type of materials. In these embodiments, tubular element 16 may or may not be movable. Preferably, the outer diameter of tubular element 16 in these embodiments is smaller than the inner diameter of nozzle 12 such that when tubular element 16 engages nozzle 1 there is a gap 30 between the outer wall of tubular element 16 and the inner wall of nozzle 12. Alternatively, tubular element 16 may be tapered at its distal end, in which case the tapered can engage nozzle 12 so as to form the gap. This alternative is not shown in FIGS. 6A-B and 7A-B, but a tapered tubular element is illustrated in FIG. 8B, and one of ordinary skills in the art, provided with the details described herein would know how to apply such a configuration also to the configuration shown in FIGS. 6A-B and 7A-B.

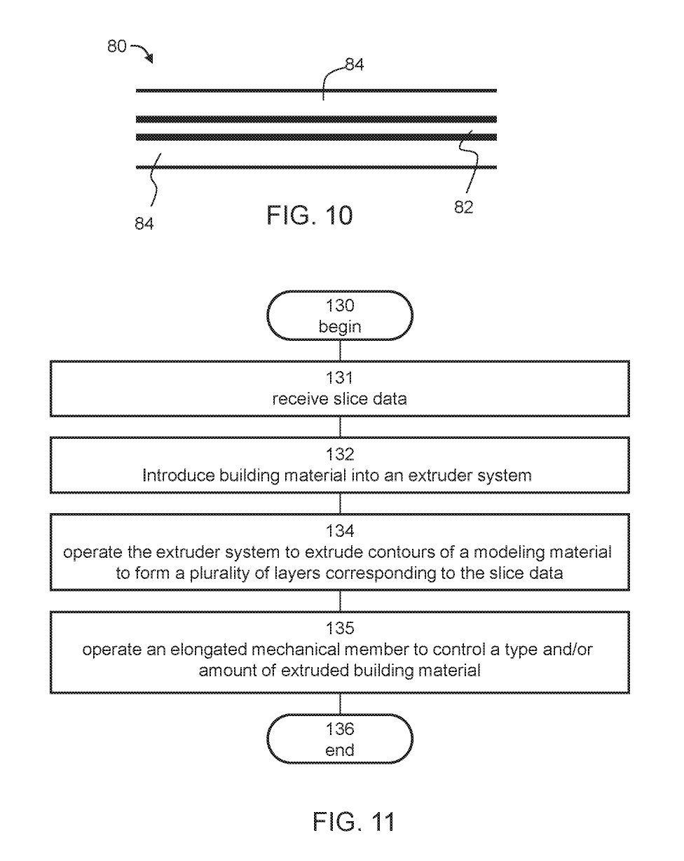

The building material that is advanced by screw 20 bypasses tubular element 16 at gap 30 and exits through nozzle 12. The additive material advances through tubular element 16 and also exits through nozzle 12, such that the building material is combined with the additive material. In various exemplary embodiments of the invention the combination forms a core-shell structure, wherein the additive material constitutes core, and the building material constitutes the shell. A representative example of a contour having a core-shell structure is illustrated in FIG. 10, showing a contour 80 having a core 82 and a shell 84 surrounding core 82.

The present embodiments contemplate many types of additive materials to be introduced into tubular element 16. Representative example include, without limitation, fluid additive material (e.g., a gaseous substance), foamed additive material, solid additive material (e.g., a solid thread or a solid filament or a fibrous substance), pigment (e.g., in the form of powder or liquid), and the like.

In some embodiments of the present invention extruder system 10 comprises a locomotion device that conveys the additive material through tubular element 16. The type of the locomotion device can be selected based on the type of additive material that is contemplated. For example, when the additive material is a flowable additive material 50 (e.g., a gaseous substance, a foam, a powder, a liquid), the locomotion device can be a pump 48 that threes the additive material into tubular member 16. These embodiments are illustrated in FIGS. 6A-B.

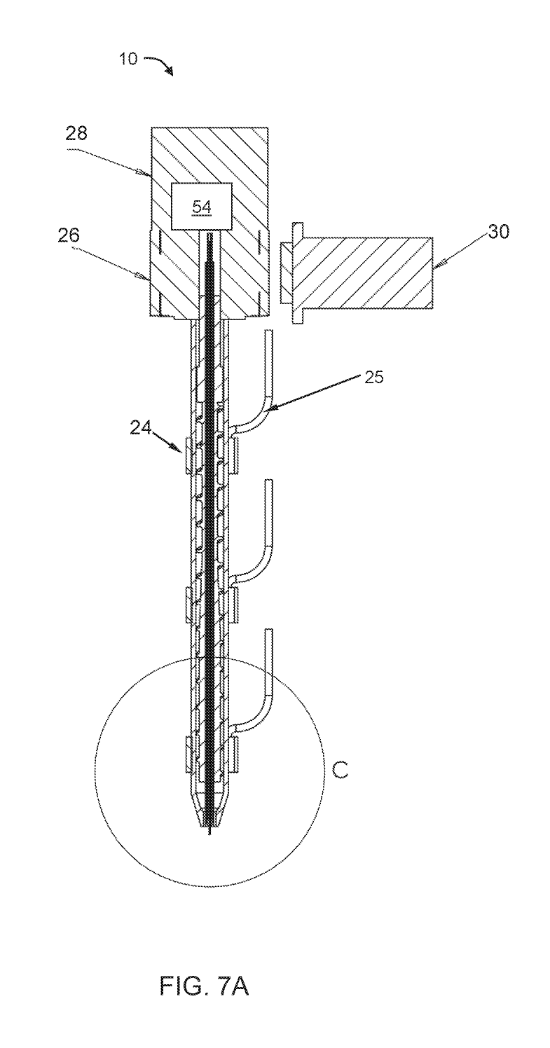

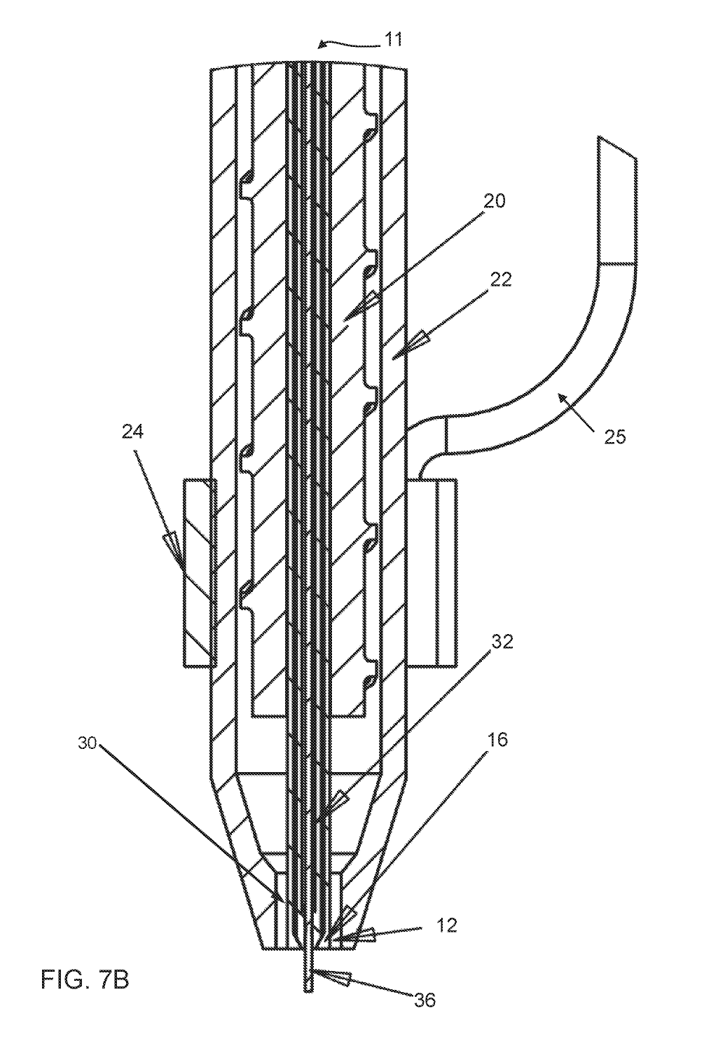

When the additive material is a solid additive material 36 (e.g., a solid thread or filament or a fibrous substance), the locomotion device can comprise a pushing member 32 that is introduced into tubular element 16 to push the additive material through tubular element 16. A representative example of this embodiment, which is not intended to be limiting, is illustrated in FIGS. 7A-B. In this example, pushing member 32 has the shape of a hollow rod having an inner diameter that is sizewise compatible with the outer diameter of material 36 so that material 36 can be introduced into the rod 32, typically while both material 36 and rod 32 are outside extruder system 10. Preferably, material 36 protrudes outwardly from rod 32. Thereafter, rod 32, now holding material 36, is introduced into tubular element 16 wherein rod 32 is advanced distally towards tip 122 to introduce material 36 into nozzle 12. Rod 32 can be advanced manually or it can be motor-driven, in which case the locomotion device also includes a motor 54 (see FIG. 7A) that advances rod 32 in tubular element 16 towards nozzle 12.

It is to be understood that it is not necessary for the additive material 36 to be in the form of a solid thread or filament or a fibrous substance in order to employ pushing member 32 as the locomotion device. Pushing member can be applied also when additive material 36 is flowable (e.g., a powder, a liquid, a foam, etc.).

FIGS. 8A-E are schematic illustrations of extruder system 10 in embodiments of the invention is which tubular element 16 comprises a plurality of lumens 42 for guiding a plurality of different types of additive materials therein. In a representative example, each of lumens 42 can guide a different pigment material so as to allow extruder system 10 to vary the color of the extruded contours. The lumens can each individually extend until the distal end of tubular element 16 such that when tubular element 16 engages nozzle 12 each additive material (e.g., pigment) arrives separately into nozzle 12. In these embodiments the building material additive materials are preferably mixed thereamongst and also with the building material outside tubular element 16, for example, in nozzle 12 or upon exiting out of nozzle 12. Preferably, tubular element 16 is constructed to allow forming gap 30 outside tubular element 16 between the inner wall of nozzle 12 and the outer wall of tubular element 16, as further detailed hereinabove (e.g., by making tubular element 16 narrower or tapered at its distal end). This allows the building material to bypass tubular element 16 and mix with the additive materials in nozzle 12.

Also contemplated are embodiments in which tubular element 16 extends throughout nozzle 12 (for example, by advancing tubular element 16 along the entire length of nozzle 12, in embodiments in which tubular element 16 is movable, or by making tubular element 16 sufficiently long in embodiments in which tubular element 16 is not movable), while maintaining gap 30. In these embodiments, the additives are combined thereamongst as well as with the building material upon extrusion. A particular application of these embodiments is to form a contour having a core-shell structure as illustrated in FIG. 10, wherein the combined additive materials constitute the core and the building material constitutes the shell.

Alternatively or additionally, two or more of lumens 42 can combine to a single lumen 43 within tubular element 16, for example, at its distal end, as illustrated in FIGS. 8B and 8C. In these embodiments the additive materials of the respective lumens are mixed at lumen 43. When tubular element 16 is provided with one or more opening(s) 18, as described above with reference to FIGS. 2B-3B, opening(s) 18 are preferably upstream with respect to lumen 43 so as to allow the mixing within lumen 43 of the additive materials of the respective lumens as well as the building material that enters tubular element 16 through opening(s) 18.

Further contemplated are combinations of the above embodiments. A representative example is an embodiment in which two or more of lumens 42 combine to a single lumen 43, opening(s) 18 are formed upstream with respect to lumen 43, and tubular element 16 extends throughout nozzle 12, while maintaining gap 30. In these embodiments, the additives are mixed thereamongst as well as with the building material within lumen 43. Upon extrusion, the mixture formed in lumen 43 is combined with the building material that bypass tubular element 16 through gap 30. A particular application of these embodiments is to form a contour having a core-shell structure as illustrated in FIG. 10, wherein the mixture of additive materials and building material constitute the core and the unmixed building material constitutes the shell.

In any of the above embodiments, when tubular element 16 is provided with one or more opening(s) 18, the opening(s) 18 are optionally and preferably provided with a unidirectional valve 40, for example, to allow the building material to enter tubular element 16 through opening(s) 18, but prevent the additive material to exit tubular element 16 through opening(s) 18, or vice versa. Optionally, valve 40 is controllable by extruder controller 28.

In any of the above embodiments, the distal end of tubular element 16 is optionally and preferably provided with a controllable valve 38 so as to controllable allow or prevent exit of materials from tubular element 16. Optionally, valve 38 is controllable by extruder controller 28.

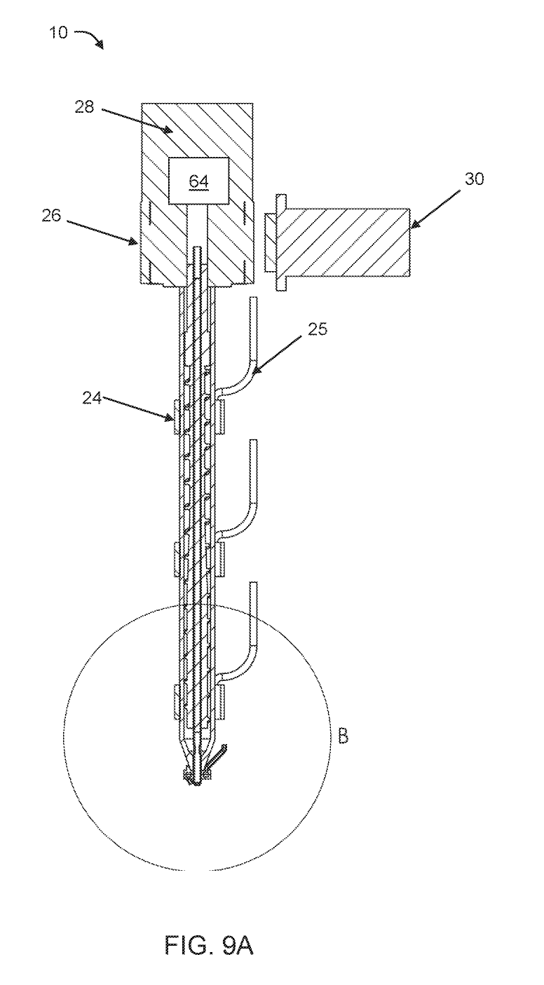

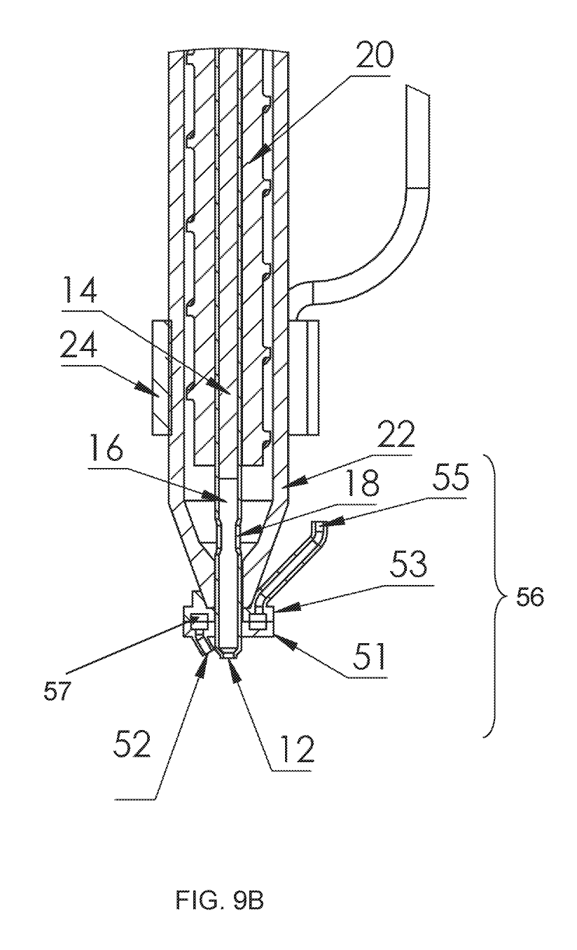

FIGS. 9A-B are schematic illustrations of extruder system 10 in embodiments of the invention in which extruder system 10 comprises a rotation for rotating nozzle 12 about an axis of barrel 22, and/or for rotating tubular element 16 about its axis relative to barrel 22. When nozzle 12 is rotated it can be rotated together with barrel 22, or, more preferably, it can be rotatably mounted on barrel 22 so as to allow nozzle 12 to rotate relative to barrel 22. When tubular element 16 is rotated it is preferably rotated independently of the rotation of screw 20. The rotation of nozzle 12 and/or tubular element 16 is optionally and preferably established by means of a motor 64. In some embodiments of the present invention motor 54 (see FIG. 7A) is also configured for establishing a rotary motion of nozzle 12 and/or tubular element 16, in which case motor 54 replaces motor 64.

Rotation of nozzle 12 and/or tubular element 16 is useful in applications in which the building material is combined with an additive material in a non-concentric manner (e.g., for reinforcing the contour or for decoration), and it desired to form a contour that is patterned by itself. For example, when the building material is combined non-concentrically with a thread or a filament, nozzle 12 and/or tubular element 16 can be rotated to form a contour having a helical pattern of the thread or a filament.

Rotation of nozzle 12 and/or tubular element 16 can also be useful for facilitating a better attachment of the extruded contour to a previously extruded contour. In this embodiment, nozzle 12 or the distal end of tubular element 16 is provided with a welding or soldering device 56 that facilitates the attachment of the extruded contour to another surface such as a previously extruded contour. Soldering device 56 optionally and preferably includes a first member 53 and a second member 51 that are connected rotatably to each other. First member 53 can be mounted statically with respect to barrel 22, so that when second member 51 rotates relative to first member 53 it also rotates relative to barrel 22. Device 56 can include an inlet 55 connected to first member 53. Inlet 55 can receive a gas or soldering medium for use during the soldering or welding. An outlet 52 for the gas or soldering medium is optionally and preferably mounted on second member 51, such that a flow of the gas or soldering medium is generated by outlet 52 at the vicinity of nozzle 12. Fluid communication between inlet 55 and outlet 52 can be ensured, for example, by means of an annular fluid channel 57 formed between first 53 and second Si members of device 56.

Typically, device 56 applies welding or soldering outwardly at an angle to the extrusion direction. In these embodiment, the rotation of nozzle 12 or the distal end of tubular element 16 is accompanied is by re-orientation of device 56 so as to allow applying the welding or soldering at a desired direction. The desired direction is typically selected by computer 128 or controller 126 based on the position of a previously applied contour relative to the position of extruder system 10.

FIG. 11 is a flowchart diagram of a method suitable for additive manufacturing of a three-dimensional object, according to some embodiments of the present invention.

Selected operations of the methods described below can be embodied in many forms. For example, they can be embodied in on a tangible medium such as a computer (e.g., computer 128) for performing the method steps. They can be embodied on a computer readable medium, optionally and preferably non-transitory computer readable medium, comprising computer readable instructions for carrying out the operations. They can also be embodied in electronic device having digital computer capabilities arranged to run the computer program on the tangible medium or execute the instruction on a computer readable medium.

Computer programs implementing some of the operations described below can commonly be distributed to users on a distribution medium such as, but not limited to, a CD-ROM or a flash drive, or they can be provided via a communication network, such as, but not limited to, the internet. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with one or more operations of the method of the present embodiments. All these operations are well-known to those skilled in the art of computer systems.

It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method begins at 130 and continues to 131 at which slice data are received. The slice data can be received from a local computer (e.g., computer 128) connected to an extrusion additive manufacturing system, such as, but not limited to, system 100 that is configured for receiving the slice data and executing the method. Alternatively, the slice data can be received from a remote computer that communicates with the system over a communication network, such as, but not limited to, a local network or the internet.

At 133 a building material is introduced into an extruder system, such as, but not limited to, extruder system 10. At 134 the extruder system is operated to extrude contours of a modeling material to form a plurality of layers corresponding to slice data of the object, and at 135 an elongated mechanical member, such as, but not limited to, elongated member 13 is operated to vary the type and/or amount of extruded building material. 134 and 135 are preferably executed simultaneously.

The method ends at 136.

Operation 135 can be executed in more than one way. In some embodiments of the present invention the elongated member is a tubular element such as, but not limited to, tubular element 16, and the method controls tubular element 16 to engage and disengage the nozzle of the extruder system, as further detailed hereinabove. In some embodiments of the present invention the tubular element comprises at least one opening formed in a wall thereof, and the mechanical member also comprises a rod, such as, but not limited to, rod 14, fitted within the tubular element. In these embodiments the method controls the amount of building material flowing through the opening(s) by moving the rod over the opening(s). In some embodiments of the present invention the method disengages the tubular element from the nozzle, to allow the nozzle to be fed by building material bypassing the tubular element.

In some embodiments of the present invention the rod is fitted within the bore of the screw, and the method controls the rod to engage and disengage said nozzle, as further detailed hereinabove.

In some embodiments of the present invention the method introduces an additive material into the tubular element to move within the tubular element into the nozzle, thereby controlling the type of extruded material by combining the additive material with the building material as further detailed hereinabove. The additive material can be of any of the types described above. In some embodiments of the present invention the method forms an extruded contour having a core-shell structure, as further detailed hereinabove. When the tubular element has a plurality of lumens, the method optionally and preferably introduces different types of additive materials to at least two separate lumens.

In some embodiments of the present invention the method rotates the nozzle about an axis of the barrel, and in some embodiments of the present invention the method rotates the tubular element about its axis relative to the barrel.

It is expected that during the life of a patent maturing from this application many relevant extrusion additive manufacturing will be developed and the scope of the term extrusion additive manufacturing system is intended to include all such new technologies a priori.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not he construed as necessarily limiting.

1. An extruder system for additive manufacturing, the extruder system comprising:
a heatable elongated barrel having a nozzle at a tip thereof; and
an extrusion screw mounted coaxially and rotatably in said barrel, such that upon rotation of said screw in said barrel an additive manufacturing building material is advanced in said barrel towards said tip;
said screw having therein an axial bore; and
at least one elongated mechanical member for controllably varying at least one of an amount and a type of material extruded through said nozzle.

2. The system according to claim 1, wherein said at least one elongated mechanical member comprises a tubular element, arranged coaxially within said bore and being axially movable therein to controllably engage and disengage said nozzle.

3. The system of claim 2, wherein said tubular element comprises at least one opening formed in a wall thereof, to allow building material advanced h said screw to enter said tubular element through said at least one opening, so that when said tubular element engages said nozzle, said nozzle is fed by building material from said tubular element.

4. The system according to claim 3, wherein said at least one mechanical member comprises a rod fitted within said tubular element and being axially movable therein and over said at least one opening to control an amount of building material flowing through said at least one opening.

5. The system according to claim 2, wherein when said tubular element is disengaged from said nozzle, said nozzle is fed by building material bypassing said tubular element.

6. The system according to claim 1, wherein said at least one elongated mechanical member comprises a rod fitted within said bore and being axially movable therein to controllably engage and disengage said nozzle.

7. The system according to claim 2, wherein said tubular element is configured to guide additive material to move within said tubular element into said nozzle, and to allow building material advanced by said screw to bypass said tubular element and also to exit through said nozzle, thereby to combine said additive material and said building material.

8. The system according to claim 1, wherein said at least one elongated mechanical member comprises a tubular element arranged coaxially within said bore to engage said nozzle, said tubular element being configured to guide additive material to move within said tubular element into said nozzle, and to allow building material advanced by said screw to bypass said tubular element and also to exit through said nozzle, thereby to combine said additive material and said building material.

9. The system according to claim 8, wherein said tubular element is configured to form an extruded contour having a core-shell structure, wherein said additive material constitutes said core, and wherein said building material constitutes said shell,

10. The system according to claim 2, further comprising a locomotion device for conveying said additive material through said tubular element.

11-12. (canceled)

13. The system according to claim 10, wherein said locomotion device comprises a pump.

14-15. (canceled)

16. The system according to claim 10, wherein said locomotion device comprises a pushing member introducible into said tubular element to push said additive material through said tubular element.

17. (canceled)

18. The system according to claim 2, wherein said tubular element has a thermally isolating wall.

19. The system according to claim 2, wherein said tubular element comprises a plurality of lumens for guiding a plurality of different types of additive materials therein.

20. The system according to claim 2, wherein said tubular element comprises at least one valve for controlling at least one of an amount and a type of additive material guided into said nozzle.

21. The system according to claim 1, further comprising a rotation device configured for rotating said nozzle about an axis of said barrel.

22. The system according to claim 1, further comprising a rotation device configured for rotating said tubular element about an axis of said tubular element, relative to said barrel.

23. The extruder system according to claim 1, incorporated in an additive manufacturing system.

24-41. (canceled)
